(19) United States
(12) Patent Application Publication
(10) Pub. No.: US 2026/0143349 A1
(43) Pub. Date: May 21, 2026

(54) INFORMATION COMMUNICATION MANAGEMENT SYSTEM OF RAIL VEHICLES

(71) Applicant: GA SKYTRAIN MOBILITY GROUP, LLC, Peachtree Corners, GA (US)

(72) Inventors: WEIFENG TANG, Jiangyin City (CN); Kui Huang, Chendu City (CN); Dong Chen, Chendu City (CN); Xiugao Zhang, Xuanhan City (CN); Bingliang Zhang, Jiangyin City (CN)

(21) Appl. No.: 19/318,549

(22) Filed: Sep. 4, 2025

(30) Foreign Application Priority Data
Nov. 19, 2024 (CN) 202411648723.2

(51) Int. Cl. H04W 16/10

(52) U.S. Cl. CPC H04W 16/10

(57) ABSTRACT

The invention discloses an information communication management system for rail vehicles, including a communication sub-network module for establishing sub-networks sharing the frequency domain resources of the wireless access network; a communication transmission rate module for calculating a communication transmission rate of users accessing the sub-network; a communication loss requirement module for defining signal transmission path loss and dynamic flow requirement of the rail vehicle; an allocation efficiency module for analyzing frequency domain resource allocation; an allocation optimization module for constructing a frequency domain resource allocation optimization function based on the frequency domain resource allocation efficiency of the wireless access network; and a resource allocation module for allocating frequency domain resources to each sub-network based on the frequency domain resource allocation optimization function and predict the optimal resource allocation state of the sub-network at the next moment through deep reinforcement learning.

### CROSS-REFERENCE TO RELATED PATENT APPLICATION

This application claims priority to and the benefit of Chinese Patent Application Serial No. 202411648723.2, filed Nov. 19, 2024, which is incorporated herein in its entirety by reference.

### FIELD OF THE INVENTION

The invention relates generally to the field of communication systems, and more particularly to an information communication management system of rail vehicles.

### BACKGROUND OF THE INVENTION

The expansion of urban scale and the increase of population make the problem of urban ground traffic congestion more and more prominent, seriously affecting people's travel efficiency and travel experience. Under such circumstances, rail transit has begun to be applied in more and more cities. Rail transit can divert the pressure of urban ground traffic, effectively alleviate traffic congestion, and also provide convenience for urban residents ‘daily travel.

Railcars and on-board network terminals move fast, communication services are diverse, and have different service requirements, such as low delay and high security for rail vehicle automatic control communication services, large bandwidth for video surveillance services, and great uncertainty for passenger service communication services. In the wireless communication environment of urban rail transit, the fast moving rail vehicles and the limited wireless signal coverage range will make the frequency domain resources of the wireless access network change continuously with the operation of the rail vehicles, thus affecting the quality of information communication service of the rail vehicles.

### SUMMARY OF THE INVENTION

In view of the above-mentioned deficiencies in the prior art, the present invention provides a rail vehicle information communication management system, which solves the problem that the existing rail vehicle information communication management system is difficult to allocate wireless access network frequency domain resources in real time and efficiently.

In order to achieve the above object of the invention, the technical scheme adopted by the present invention is as follows:

The invention provides an information communication management system for a rail vehicle, comprising:
a communication sub-network module, configured to establish a plurality of sub-networks that share the frequency domain resources of the wireless access network;
a communication transmission rate module, configured to calculate the communication transmission rate of users accessing the sub-network based on the channel bandwidth allocated by the sub-network to the users accessing the sub-network and the signal-to-noise ratio of the users on the channel;
a communication loss requirement module, which is used for defining signal transmission path loss and dynamic flow requirement of the rail vehicle;
an allocation efficiency module, configured to perform frequency domain resource allocation analysis according to the communication transmission rate of the user accessing the sub-network, the signal transmission path loss of the rail vehicle, and the dynamic traffic demand, and obtain the frequency domain resource allocation efficiency of the wireless access network;
an allocation optimization module, configured to construct a frequency domain resource allocation optimization function based on the frequency domain resource allocation efficiency of the wireless access network; and
a resource allocation module, configured to allocate frequency domain resources to each sub-network based on the frequency domain resource allocation optimization function and predict the optimal resource allocation state of the sub-network at the next moment through deep reinforcement learning.

The invention has the beneficial effects that the information communication management system of the rail vehicle provided by the invention establishes a plurality of sub-networks for sharing the wireless access network frequency domain resources of the rail vehicle through the communication sub-network module according to different service types, and provides a basis for allocating the wireless access network frequency domain resources obtained when the train travels according to the service types; Through the communication transmission rate module, the communication transmission rate of the user accessing the sub-network is calculated according to the communication resources allocated to the user by the sub-network, and through the communication loss requirement module, the signal transmission path loss on the rail vehicle and the dynamic flow requirement amount in the unit transmission time of each sub-network are defined, thereby providing a basis for determining the frequency domain resource allocation efficiency of the wireless access network of each sub-network; According to the frequency domain resource allocation optimization function, the resource allocation module realizes optimal allocation of the frequency domain resources of the wireless access network dynamically changing on the rail vehicle based on deep reinforcement learning, and greatly improves the efficiency of allocating the frequency domain resources of the wireless access network under the condition of ensuring normal and stable operation of services.

Other advantages of the present invention will be analyzed in greater detail in the following embodiments.

### BRIEF DESCRIPTION OF THE DRAWINGS

In order to more clearly illustrate the technical solutions of the embodiments of the present invention, the following briefly introduces the drawings required for use in the embodiments. It should be understood that the following drawings only illustrate certain embodiments of the present invention and should not be regarded as limiting the scope. For those skilled in the art, other relevant drawings can be obtained based on these drawings without creative work.

FIG. 1 is a block diagram of an information communication management system for a rail vehicle provided by the present invention.

### DETAILED DESCRIPTION OF THE INVENTION

The technical solutions in the embodiments of the present invention will be clearly and completely described below in conjunction with the drawings in the embodiments of the present invention. Obviously, the described embodiments are only part of the embodiments of the present invention, not all of the embodiments. The components of the embodiments of the present invention generally described and shown in the drawings herein can be arranged and designed in various different configurations. Therefore, the following detailed description of the embodiments of the present invention provided in the drawings is not intended to limit the scope of the claimed invention, but merely represents selected embodiments of the present invention. Based on the embodiments of the present invention, all other embodiments obtained by those skilled in the art without making creative work are within the scope of protection of the present invention.

SLA (Service Level Agreement), a service level agreement that specifies the quality of service.

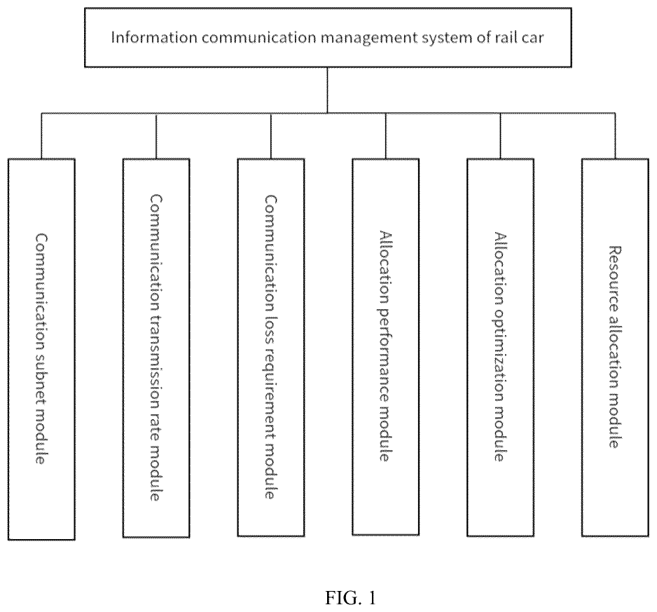

As shown in FIG. 1, in an embodiment of the present invention, the present invention provides an information communication management system for a rail vehicle, comprising:

A communication sub-network module, configured to establish a plurality of sub-networks sharing frequency domain resources of a wireless access network, wherein the sub-networks can meet the differentiated requirements of different services on network capabilities by constructing a plurality of dedicated, virtualized and mutually isolated logical networks on a common physical network, and the sub-networks can reduce the cost of constructing a plurality of private networks and simultaneously provide highly flexible network services deployed on demand; In this embodiment, the types of the sub-networks include a low-delay traffic sub-network, a bandwidth-enhanced traffic sub-network, and a bandwidth-enhanced public sub-network. The low-delay traffic sub-network is an ultra-high reliability and low-delay communication sub-network constructed based on rail transit frequency band resources, the bandwidth-enhanced traffic sub-network is an enhanced mobile broadband communication sub-network constructed based on rail transit frequency band resources, and the bandwidth-enhanced traffic public sub-network is an enhanced mobile broadband communication sub-network constructed based on public frequency band resources.

A communication transmission rate module, configured to calculate the communication transmission rate of users accessing the sub-network based on the channel bandwidth allocated by the sub-network to the users accessing the sub-network and the signal-to-noise ratio of the users on the channel;

A calculation expression of the communication transmission rate of the access user in the sub-network is as follows:

$${r}_{u} = {W}_{s , u} {log}_{2} ( 1 + {SNR}_{u} ) ,$$

$${\sum }_{u ∈ {U}_{s}} {W}_{s , u} = {W}_{s} , ∀ s ∈ \{ {s}_{1} , {s}_{2} , … , {s}_{i} , … , {s}_{n} \} ,$$

$${SNR}_{u} = \frac{{p}_{u} {h}_{u}}{{I}_{u} + {N}_{0} {W}_{s , u}} ,$$

wherein rᵤ represents the communication transmission rate of the user accessing the sub-network, W_{s,u} represents the channel bandwidth allocated by the sub-network to the user accessing the sub-network, s represents the sub-network, u represents the user accessing the sub-network, log₂ represents a logarithmic function with base 2, SNRᵤ represents the signal-to-noise ratio of the user accessing the sub-network on the channel, ∈ means belonging to, Uₛ represents the user set accessing the sub-network, ∀ represents any, S₁ represents the 1st sub-network, S₂ represents the 2nd sub-network, Sᵢ represents the i-th sub-network, Sₙ denotes the n-th sub-network, pᵤ denotes the power allocated by the base station to users accessing the sub-network, hᵤ denotes channel gain, Iᵤ denotes interference of other signals, N₀ denotes noise power spectral density, wherein n is the total number of sub-networks, and i=1, 2, . . . , n.

A communication loss requirement module, which is used for defining signal transmission path loss and dynamic flow requirement of the rail vehicle.

The calculation expressions of the signal transmission path loss and the dynamic traffic demand are respectively as follows:

$$SPL ( d ) = {SPL}_{c} + {L}_{TtoA} \times {SPL}_{T} ,$$

$$d = \{ {d}_{1} , {d}_{2} , … , {d}_{i} , … , {d}_{n} \} , {d}_{i} = {\sum }_{u ∈ {Us}_{i}} \vert {Q}_{u} \vert ,$$

where SPL (d) represents a signal transmission path loss, SPL_{c} represents coupling loss, L_{TtoA} represents a distance between a terminal and an antenna, SPL_{T} represents wireless signal transmission loss coefficient, d represents a set of dynamic traffic demands in a transmission time interval, d₁ represents a dynamic traffic demand of the first sub-network in the transmission time interval, d₂ represents a dynamic traffic demand of the second sub-network in the transmission time interval, dᵢ represents a dynamic traffic demand of the i-th sub-network in the transmission time interval, dₙ represents the dynamic traffic demand of the n-th sub-network in the transmission time interval, and represents the data packet set transmitted between all users accessing the i-th sub-network and the base station in the transmission time interval. In this embodiment, the dynamic traffic demand reflects the data packet transmission volume in the transmission time interval.

An allocation efficiency module, configured to perform frequency domain resource allocation analysis according to the communication transmission rate of the user accessing the sub-network, the signal transmission path loss of the rail vehicle, and the dynamic traffic demand, and obtain the frequency domain resource allocation efficiency of the wireless access network. The allocation efficiency module includes:

An SLA constraint sub-module, configured to respectively constrain the data transmission rate, the data transmission delay and the channel bandwidth of each sub-network in the communication transmission time interval to obtain SLA constraints.

The SLA constraint calculation expression is as follows:

$${r}_{u} \geq {R}_{req , s} , {l}_{u} \leq {L}_{req , s} , {W}_{s , u} \leq {W}_{allo , s} ,$$

wherein R_{freq,s} represents a data transmission rate threshold, lᵤ represents a data transmission delay of a communication transmission time interval, L_{req,s} represents a data transmission delay threshold, W_{allo,s} represents a channel bandwidth threshold allocated to a sub-network.

An SLA satisfaction rate sub-module, configured to calculate an SLA satisfaction rate based on SLA constraints and in combination with dynamic packet transmission volume of the sub-network.

The SLA satisfaction rate calculation expression is as follows:

$${SSR}_{s} = {\sum }_{u ∈ {U}_{s}} {\sum }_{{q}_{u} ∈ {Q}_{u}} {x}_{{q}_{u}} / {\sum }_{u ∈ {U}_{s}} \vert {Q}_{u} \vert ,$$

wherein SSRₛ represents SLA satisfaction rate of the sub-network, qᵤ represents data packets transmitted by users accessing the sub-network in communication transmission time interval, x_{qu} represents SLA constraint satisfaction variable of the sub-network,

$${\sum }_{u ∈ {U}_{s}} \vert {Q}_{u} \vert$$

represents data packet set transmitted between all users accessing the sub-network and base station in transmission time interval;

In this embodiment, when the base station and the user accessing the sub-network successfully transmit the data packet qu within the communication transmission time interval under the conditions that the rate is not less than the data transmission rate threshold R_{req,s}, the data transmission delay is not greater than the data transmission delay threshold L_{req,s}, and the occupied channel does not exceed the channel bandwidth threshold allocated to the sub-network, the SLA constraint satisfaction variable is 1, otherwise it is 0.

A frequency-domain allocation efficiency sub-module, configured to calculate frequency-domain resource allocation efficiency of a wireless access network based on the SLA satisfaction rate and in combination with frequency-domain resource utilization efficiency;

A calculation expression of the wireless access network frequency domain resource allocation efficiency is as follows:

$$EF ( d , ω ) = {\sum }_{s ∈ \{ {s}_{1} , {s}_{2} , ⋯ , {s}_{n} \}} {β}_{s} {SSR}_{s} ( d , ω ) + α SE ( d , ω ) ,$$

$$SE ( d , ω ) = \frac{{\sum }_{s ∈ \{ {s}_{1} , {s}_{2} , ⋯ , {s}_{n} \}} {\sum }_{u ∈ {U}_{s}} {r}_{u}}{W} ,$$

$$ω = \{ {W}_{1} , {W}_{2} , ⋯ , {W}_{i} , ⋯ , {W}_{n} \} ,$$

wherein EF(d,ω) represents the wireless access network frequency domain resource allocation efficiency, βₛ represents the SLA satisfaction rate weighting factor, SSRₛ(d,ω) represents the SLA satisfaction rate based on the dynamic traffic demand and the sub-network frequency domain resources, α represents the frequency domain resource utilization efficiency weighting factor, SE(d,ω) represents the frequency domain resource utilization efficiency based on the dynamic traffic demand and the sub-network frequency domain resources,

$${\sum }_{s ∈ \{ {s}_{1} , {s}_{2} , ⋯ , {s}_{n} \}} {\sum }_{u ∈ {U}_{s}} {r}_{u}$$

represents the sum of the communication transmission rates of all users accessing all sub-networks, W represents the total frequency domain resources of the fixed bandwidth of the base station, ω represents the frequency domain resources allocated to the sub-network, W₁ denotes frequency domain resources allocated to the 1st sub-network, Wᵢ denotes frequency domain resources allocated to the i-th sub-network, Wₙ denotes frequency domain resources allocated to the n-th sub-network.

An allocation optimization module, configured to construct a frequency domain resource allocation optimization function based on the frequency domain resource allocation efficiency of the wireless access network;

A calculation expression of the frequency-domain resource allocation optimization function is as follows:

$$argmax EF ( d , ω ) = argmax ( {\sum }_{s ∈ \{ {s}_{1} , {s}_{2} , ⋯ , {s}_{n} \}} {β}_{s} {SSR}_{s} ( d , ω ) + α SE ( d , ω ) ) , s . t .$$

$${\sum }_{s ∈ \{ {s}_{1} , {s}_{2} , ⋯ , {s}_{n} \}} {W}_{s} = W , ω = \{ {W}_{1} , {W}_{2} , ⋯ , {W}_{n} \} ,$$

$$d = \{ {d}_{1} , {d}_{2} , ⋯ , {d}_{n} \} , {d}_{s} = {\sum }_{u ∈ {U}_{s}} \vert {Q}_{u} \vert ,$$

where arg max denotes the maximum argument point set function, s.t. denotes such that.

A resource allocation module, configured to allocate frequency domain resources to each sub-network based on the frequency domain resource allocation optimization function and predict the optimal resource allocation state of the sub-network at the next moment through deep reinforcement learning.

The resource allocation module comprises:

An allocation state defining submodule, configured to take the dynamic traffic demand at each time from the previous T times to the current time of each sub-network as the resource allocation state of the sub-network at the current time, and predict and obtain the dynamic traffic demand at the next time of the sub-network based on the resource allocation state of the sub-network by using the BiGRU network as the resource allocation state of the sub-network at the next time.

The calculation expression of the resource allocation state of the sub-network at the next time is as follows:

$${y}_{st + 1} = soft max ( {W}^{′} {h}_{t} + b ) ,$$

$${h}_{t} = [ {\vec{h}}_{t} ; {\overleftarrow{h}}_{t} ] ,$$

$$\vec{h} = GRU ( {\vec{h}}_{t - 1} , {y}_{st} ) , \overleftarrow{h} = GRU ( {\overleftarrow{h}}_{t + 1} , {y}_{st} ) ,$$

$${y}_{st} = \{ {d}_{st - T ,} {d}_{st - T + 1 , ⋯ ,} {d}_{st - 1} , {d}_{st} \} ,$$

wherein yₛₜ₊₁ represents the resource allocation state of the sub-network at the next time, softmax(⋅) represents the softmax activation function, W′ represents the weight of the fully connected layer, hₜ represents the final hidden state at the current time, b represents the bias of the fully connected layer, \vec{h}ₜ represents the forward hidden state at the current time, \vec{h}ₜ₋₁ represents the forward hidden state at the previous time, [symbol] represents the backward hidden state at the current time, [symbol] represents the backward hidden state at the next time, [⋅;⋅] represents the splicing operation, GRU(⋅) represents the GRU unit, yₛₜ represents the resource allocation state of the sub-network at the current time, d_{t-T} represents the dynamic traffic demand of the sub-network before time T, d_{t-T+1} represents the dynamic traffic demand of the sub-network before time T-l, dₜ₋₁ represents the dynamic traffic demand of the sub-network at the previous time, dₛₜ represents the dynamic traffic demand of the sub-network at the current time;

In this embodiment, the dynamic traffic demand of the sub-network reflects the data packet transmission volume within the transmission time interval, and the data packet transmission volume of the communication service itself is a type of time series data capable of performing time series prediction. Since the service types of different sub-networks are different, and there is no obvious time correlation between the dynamic traffic demands of different service types, the time series prediction of the dynamic traffic demand can only be performed for each sub-network respectively. Because the rail vehicle moves faster and the available wireless access network frequency domain resources change faster, the dynamic traffic demand corresponding to each sub-network changes faster, which is equivalent to short-time fast time sequence prediction, and has shorter sequence length and higher requirements on calculation efficiency, so that the BiGRU network is adopted in the scheme to predict the dynamic traffic demand at the next time, so as to execute optimal wireless access network frequency domain resource allocation according to the prediction result.

An action definition sub-module, configured to use the channel bandwidth allocated to each sub-network as a resource allocation action of the sub-network to obtain a resource allocation action space.

A calculation expression of the resource allocation action space is as follows:

$$A = \{ {a}_{1} , {a}_{2} , ⋯ , {a}_{j} , ⋯ , {a}_{p} \} ,$$

$${a}_{j} = \{ {ω}_{j 1} , {ω}_{j 2} , ⋯ , {ω}_{jn} \} ,$$

where A represents a resource allocation action space, a₁ represents a first resource allocation action for allocating channel bandwidths to sub-networks, aⱼ represents a j-th resource allocation action for allocating channel bandwidths to sub-networks, a_{P} represents a p-th resource allocation action for allocating channel bandwidths to sub-networks, ωⱼ₁ represents channel bandwidths allocated to the first sub-network under the j-th resource allocation action, ωⱼₙ represents channel bandwidths allocated to the n-th sub-network under the j-th resource allocation action, where p is the total number of actions in the resource allocation action space;

A reward function definition submodule, configured to construct a resource allocation reward function according to the frequency domain resource allocation optimization function.

A calculation expression of the resource allocation reward function is as follows:

$$R ( SSR , SE ) = {{f}_{1}}_{s ∈ ( {s}_{1} , {s}_{2} , ⋯ , {s}_{i} , ⋯ , {s}_{n} \}} ( {SSR}_{s} ) + λ {f}_{2} ( SE ) ,$$

$${{f}_{1}}_{s ∈ ( {s}_{1} , {s}_{2} , ⋯ , {s}_{i} , ⋯ , {s}_{n} \}} ( {SSR}_{s} ) = {\sum }_{s ∈ ( {s}_{1} , {s}_{2} , ⋯ , {s}_{i} , ⋯ , {s}_{n} \}} {η}_{s} ( {SSR}_{s} - {SSR}_{0} ) ,$$

$${f}_{2} ( SE ) = γ \cdot ( SE - {SE}_{0} ) ,$$

wherein R(SSR, SE) represents resource allocation reward function,

$${{f}_{1}}_{s ∈ ( {s}_{1} , {s}_{2} , ⋯ , {s}_{i} , ⋯ , {s}_{n} \}} ( {SSR}_{s} )$$

represents sub-network SLA satisfaction rate reward function, λ represents SLA satisfaction variable weight, f₂(SE) represents frequency domain resource utilization rate reward function, ηₛ represents sub-network priority coefficient, SSR₀ represents lowest SLA satisfaction rate threshold, γ represents frequency domain resource utilization rate weight, SE represents frequency domain resource utilization efficiency, SE₀ represents lowest frequency domain resource utilization efficiency threshold;

In this embodiment, if the SLA satisfaction rates of all the sub-networks are not lower than the lowest SLA satisfaction rate threshold, the SLA satisfaction variable weight is 1, otherwise, the SLA satisfaction variable weight is 0. In this embodiment, the sub-network priority coefficient corresponding to the communication service related to the rail vehicle is greater than the sub-network priority coefficient corresponding to the communication service not related to the rail vehicle, so as to ensure the safe and stable operation of the rail vehicle preferentially. Based on the resource allocation reward function, the stability of the communication service can be ensured, and a basis can be provided for evaluating the frequency domain resource utilization rate of the sub-network, so that the frequency domain resource utilization rate of the wireless access network can be further improved.

A resource allocation sub-module, configured to predict and obtain an optimal resource allocation state of the sub-network at the next time through deep reinforcement learning according to the resource allocation action space and the resource allocation reward function, and complete allocation of wireless access network frequency domain resources to each sub-network.

The resource allocation sub-module comprises:

An execution network unit, configured to obtain a resource allocation action probability distribution according to the execution network parameters, the resource allocation state of the sub-network at the next time and the resource action allocation space, and sample to obtain a target resource allocation action;

The evaluation network unit is used for evaluating the resource allocation state at each time according to the evaluation network parameters to obtain the resource allocation state value at each time.

A state action evaluation unit, configured to evaluate the resource allocation state of the sub-network at the current time and the target resource allocation action at the current time to obtain a state action evaluation result.

A calculation expression of the state action evaluation result is as follows:

$$G ( {y}_{st} , {a}_{t} ) = {r}_{t} = ς V ( {y}_{st + 1} \vert {y}_{st} , {a}_{t} ) - V ( {y}_{st} ) ,$$

wherein G(yₛₜ,aₜ) represents the state action evaluation result, rₜ represents the instant reward obtained by executing the target resource allocation action at the current time in the resource allocation state of the sub-network at the current time, ζ represents the state transition value discount factor, V(yₛₜ₊₁|yₛₜ,aₜ) represents the evaluation value of the resource allocation state of the sub-network at the current time being transferred to the resource allocation state of the sub-network at the next time through the target resource allocation action at the current time, V(yₛₜ) represents the value of the resource allocation state of the sub-network at the current time.

An execution network parameter updating unit, configured to update the execution network parameters based on an execution network parameter updating model according to the execution network parameters and evaluation network parameters at the current time, the resource allocation state of the sub-network at the current time, the target resource allocation action at the current time, the resource allocation state of the sub-network at the next time, and the state action evaluation result.

An evaluation network parameter updating unit, configured to update evaluation network parameters based on an evaluation network parameter updating model according to evaluation network parameters and execution network parameters at the current time, a resource allocation state of the sub-network at the current time, a target resource allocation action at the current time, a resource allocation state of the sub-network at the next time, and a state action evaluation result.

The calculation expressions of the execution network parameter update model and the evaluation network parameter update model are respectively as follows:

$${θ}_{a} ⟸ {θ}_{a} + \frac{\partial log π ( {a}_{t} \vert {y}_{st} ; {θ}_{a} )}{\partial {θ}_{a}} ( {r}_{t} + ς V ( {y}_{st + 1} ; {θ}_{c} ) - V ( {y}_{st} ; {θ}_{c} ) ) ,$$

$${θ}_{c} ⟸ {θ}_{c} + \frac{\partial V ( {y}_{st} ; {θ}_{c} )}{\partial {θ}_{c}} ( {r}_{t} + ς V ( {y}_{st + 1} ; {θ}_{c} ) - V ( {y}_{st} ; {θ}_{c} ) ) ,$$

wherein θₐ represents the execution network parameter, [symbol] represents the assignment update, log represents the logarithmic operation, π(aₜ|yₛₜ; θₐ) represents the probability that the execution network selects the target resource allocation action at the current time in the resource allocation state of the sub-network at the current time, log π(aₜ|yₛₜ; θₐ) represents the logarithm of the probability,

$$\frac{\partial log π ( {a}_{t} \vert {y}_{st} ; {θ}_{a} )}{\partial {θ}_{a}}$$

represents the gradient of the logarithm of the probability with respect to the execution network parameter, V(yₛₜ₊₁;θ_{c}) represents the evaluation value of the evaluation network for the resource allocation state of the sub-network at the next time, V(yₛₜ₊₁;θ_{c}) represents the evaluation value of the evaluation network for the resource allocation state of the sub-network at the current time, θ_{c} represents the evaluation network parameter,

$$\frac{\partial V ( {y}_{st} ; {θ}_{c} )}{\partial {θ}_{c}}$$

represents the evaluation value of the evaluation network on the resource allocation state of the sub-network at the current time with respect to the gradient of the evaluation network parameter.

A resource allocation optimization unit, configured to obtain the optimal resource allocation state of the sub-network at the next time based on the optimal resource allocation model according to the resource allocation reward function, the target resource allocation action and the resource allocation state value at the next time, and complete the allocation of wireless access network frequency domain resources to each sub-network.

A calculation expression of the optimal resource allocation model is as follows:

$${V}^{′} ( {y}_{st + 1} ) = argmax \{ {r}_{t} + ϛ V ( {y}_{st + 1} \vert {y}_{st} , {a}_{t} ) V ( {y}_{st} ) \} ,$$

wherein V′(yₛₜ₊₁) represents the optimal value of executing the target resource allocation action at the current time in the resource allocation state of the sub-network at the current time to transfer to the resource allocation state of the sub-network at the next time.

Based on the optimal resource allocation module, according to the maximum corresponding result of the resource allocation reward function, the resource allocation state of the sub-network at the next time corresponding to the optimal value can be obtained, which is taken as the optimal resource allocation state of the sub-network at the next time, and according to the optimal resource allocation state of the sub-network at the next time, the wireless access network frequency domain resources at the time are allocated to each sub-network, and the allocation of the wireless access network frequency domain resources to each sub-network is completed. Through the information communication management system of the rail vehicle provided by the scheme, the utilization rate and the allocation efficiency of the frequency domain resources obtained from the wireless access network in real time in the traveling process of the rail vehicle can be effectively improved.

The above description is only a specific embodiment of the present invention, but the scope of protection of the present invention is not limited thereto. Any person skilled in the art may easily think of changes or substitutions within the technical scope disclosed by the present invention, which should be covered by the scope of protection of the present invention.

What is claimed is:

1. An information communication management system for a rail vehicle, comprising:
a communication sub-network module, configured to establish a plurality of sub-networks that share the frequency domain resources of a wireless access network;
a communication transmission rate module, configured to calculate a communication transmission rate of users accessing the sub-network based on the channel bandwidth allocated by the sub-network to the users accessing the sub-network and the signal-to-noise ratio of the users on the channel;
a communication loss requirement module, configured to define signal transmission path loss and dynamic flow requirement of the rail vehicle;
an allocation efficiency module, configured to perform frequency domain resource allocation analysis according to the communication transmission rate of the user accessing the sub-network, the signal transmission path loss of the rail vehicle, and the dynamic traffic demand, and obtain the frequency domain resource allocation efficiency of the wireless access network;
an allocation optimization module, configured to construct a frequency domain resource allocation optimization function based on the frequency domain resource allocation efficiency of the wireless access network; and
a resource allocation module, configured to allocate frequency domain resources to each sub-network based on the frequency domain resource allocation optimization function and predict the optimal resource allocation state of the sub-network at the next moment through deep reinforcement learning

2. The information communication management system of claim 1, wherein a calculation expression of the communication transmission rate of the access users in the sub-network is as follows:
$${r}_{u} = {W}_{s , u} {log}_{2} ( 1 + {SNR}_{u} ) ,$$
$${\sum }_{u ∈ {U}_{s}} {W}_{s , u} = {W}_{s} , ∀ s ∈ \{ {s}_{1} , {s}_{2} , ⋯ , {s}_{i} , ⋯ , {s}_{n} \} ,$$
$${SNR}_{u} = \frac{{p}_{u} {h}_{u}}{{I}_{u} + {N}_{0} {W}_{s , u}} ,$$
wherein rᵤ represents the communication transmission rate of the user accessing the sub-network, W_{s,u} represents the channel bandwidth allocated by the sub-network to the user accessing the sub-network, s represents the sub-network, u represents the user accessing the sub-network, log₂ represents a logarithmic function with base 2, SNRᵤ represents the signal-to-noise ratio of the user accessing the sub-network on the channel, ∈ means belonging to, Uₛ represents the user set accessing the sub-network, ∀ represents any, S₁ represents the 1st sub-network, S₂ represents the 2nd sub-network, Sᵢ represents the i-th sub-network, Sₙ denotes the n-th sub-network, pᵤ denotes the power allocated by the base station to users accessing the sub-network, denotes channel gain, Iᵤ denotes interference of other signals, N₀ denotes noise power spectral density, wherein n is the total number of sub-networks, and i=1, 2, . . . , n.

3. The information communication management system of claim 2, wherein the calculation expressions of the signal transmission path loss and the dynamic traffic demand are respectively as follows:
$$SPL ( d ) = {SPL}_{c} + {L}_{TtoA} \times {SPL}_{T} ,$$
$$d = \{ {d}_{1} , {d}_{2} , … , {d}_{i} , ⋯ , {d}_{n} \} , {d}_{i} = {\sum }_{u ∈ {Us}_{i}} \vert {Q}_{u} \vert ,$$
wherein SPL(d) represents a signal transmission path loss, SPL_{c} represents coupling loss, L_{TtoA} represents a distance between a terminal and an antenna, SPL_{T} represents wireless signal transmission loss coefficient, d represents a set of dynamic traffic demands in a transmission time interval, d₁ represents a dynamic traffic demand of the first sub-network in the transmission time interval, d₂ represents a dynamic traffic demand of the second sub-network in the transmission time interval, dᵢ represents a dynamic traffic demand of the i-th sub-network in the transmission time interval, dₙ represents the dynamic traffic demand of the n-th sub-network in the transmission time interval, and represents the data packet set transmitted between all users accessing the i-th sub-network and the base station in the transmission time interval.

4. The information communication management system of claim 3, wherein the efficiency allocation module comprises:
an SLA constraint sub-module, configured to respectively constrain the data transmission rate, the data transmission delay and the channel bandwidth of each sub-network in the communication transmission time interval to obtain SLA constraints; wherein the SLA constraint calculation expression is as follows:
$${r}_{u} \geq {R}_{req , s} , {l}_{u} \leq {L}_{req , s} , {W}_{s , u} \leq {W}_{allo , s} ,$$
wherein R_{req,s} represents a data transmission rate threshold, lᵤ represents a data transmission delay of a communication transmission time interval, L_{req,s} represents a data transmission delay threshold, W_{allo,s} represents a channel bandwidth threshold allocated to a sub-network;
an SLA satisfaction rate sub-module, configured to calculate an SLA satisfaction rate based on SLA constraints and in combination with dynamic packet transmission volume of the sub-network; where the SLA satisfaction rate calculation expression is as follows:
$${SSR}_{s} = {\sum }_{u ∈ {U}_{s}} {\sum }_{{q}_{u} ∈ {Q}_{u}} {x}_{{q}_{u}} / {\sum }_{u ∈ {U}_{s}} \vert {Q}_{u} \vert ,$$
wherein SSRₛ represents SLA satisfaction rate of the sub-network, qᵤ represents data packets transmitted by users accessing the sub-network in communication transmission time interval, x_{qu} represents SLA constraint satisfaction variable of the sub-network,
$${\sum }_{u ∈ {U}_{s}} \vert {Q}_{u} \vert$$
represents data packet set transmitted between all users accessing the sub-network and base station in transmission time interval; and
a frequency-domain resource allocation efficiency sub-module, configured to calculate frequency-domain resource allocation efficiency of the wireless access network based on the SLA satisfaction rate and in combination with the frequency-domain resource utilization efficiency, wherein a calculation expression of the frequency-domain resource allocation efficiency of the wireless access network is as follows:
$$EF ( d , ω ) = {\sum }_{s ∈ \{ {s}_{1} , {s}_{2} , ⋯ , {s}_{n} \}} {β}_{S} {SSR}_{S} ( d , ω ) + α SE ( d , ω ) ,$$
$$SE ( d , ω ) = \frac{{\sum }_{s ∈ \{ {s}_{1} , {s}_{2} , ⋯ , {s}_{n} \}} {\sum }_{u ∈ {U}_{s}} {r}_{u}}{W} ,$$
$$ω = \{ {W}_{1} , {W}_{2} , ⋯ , {W}_{i} , ⋯ , {W}_{n} \} ,$$
wherein EF(d,ω) represents the wireless access network frequency domain resource allocation efficiency, βₛ represents the SLA satisfaction rate weighting factor, SSRₛ(d,ω) represents the SLA satisfaction rate based on the dynamic traffic demand and the sub-network frequency domain resources, α represents the frequency domain resource utilization efficiency weighting factor, SE (d,ω) represents the frequency domain resource utilization efficiency based on the dynamic traffic demand and the sub-network frequency domain resources,
$${\sum }_{s ∈ \{ {s}_{1} , {s}_{2} , ⋯ , {s}_{n} \}} {\sum }_{u ∈ {U}_{s}} {r}_{u}$$
represents the sum of the communication transmission rates of all users accessing all sub-networks, W represents the total frequency domain resources of the fixed bandwidth of the base station, ω represents the frequency domain resources allocated to the sub-network, W₁ denotes frequency domain resources allocated to the 1st sub-network, Wₗ denotes frequency domain resources allocated to the i-th sub-network, Wₙ denotes frequency domain resources allocated to the n-th sub-network.

5. The information communication management system of claim 4, wherein a calculation expression of the frequency domain resource allocation optimization function is as follows:
$$argmax EF ( d , ω ) = argmax ( {\sum }_{s ∈ \{ {s}_{1} , {s}_{2} , ⋯ , {s}_{n} \}} {β}_{S} {SSR}_{S} ( d , ω ) + α SE ( d , ω ) ) , s . t .$$
$${\sum }_{s ∈ \{ {s}_{1} , {s}_{2} , ⋯ , {s}_{n} \}} {W}_{s} = W , ω = \{ {W}_{1} , {W}_{2} , ⋯ , {W}_{n} \} ,$$
$$d = \{ {d}_{1} , {d}_{2} , ⋯ , {d}_{n} \} , {d}_{s} = {\sum }_{u ∈ {U}_{s}} \vert {Q}_{u} \vert ,$$
Wherein arg max denotes the maximum argument point set function, s.t. denotes such that.

6. The information communication management system of claim 5, wherein the resource allocation module comprises:
an allocation state defining sub-module, configured to take the dynamic traffic demand at each time from the previous T times to the current time of each sub-network as the resource allocation state of the sub-network at the current time, and predict and obtain the dynamic traffic demand at the next time of the sub-network based on the resource allocation state of the sub-network by using the BiGRU network as the resource allocation state of the sub-network at the next time;
a calculation expression of the resource allocation state of the sub-network at the next time is as follows:
$${y}_{st + 1} = soft max ( {W}^{′} {h}_{t} + b ) ,$$
$${h}_{t} = [ {\vec{h}}_{t} ; {\overleftarrow{h}}_{t} ] ,$$
$$\vec{h} = GRU ( {\vec{h}}_{t - 1} , {y}_{st} ) , \overleftarrow{h} = GRU ( {\overleftarrow{h}}_{t + 1} , {y}_{st} ) ,$$
$${y}_{st} = \{ {d}_{st - T ,} {d}_{st - T + 1} , ⋯ , {d}_{st - 1} , {d}_{st} \} ,$$
wherein, yₛₜ₊₁ represents the resource allocation state of the sub-network at the next time, softmax(⋅) represents the softmax activation function, W′ represents the weight of the fully connected layer, hₜ represents the final hidden state at the current time, b represents the bias of the fully connected layer, \vec{h}ₜ represents the forward hidden state at the current time, \vec{h}ₜ₋₁ represents the forward hidden state at the previous time, [symbol] represents the backward hidden state at the current time, [symbol] represents the backward hidden state at the next time, [⋅;⋅] represents the splicing operation, GRU(⋅) represents the GRU unit, yₛₜ represents the resource allocation state of the sub-network at the current time, d_{t-T} represents the dynamic traffic demand of the sub-network before time T, d_{t-T+1} represents the dynamic traffic demand of the sub-network before time T-l, dₜ₋₁ represents the dynamic traffic demand of the sub-network at the previous time, dₛₜ represents the dynamic traffic demand of the sub-network at the current time;
an action definition sub-module, configured to use the channel bandwidth allocated to each sub-network as a resource allocation action of the sub-network to obtain a resource allocation action space;
a calculation expression of the resource allocation action space is as follows:
$$A = \{ {a}_{1} , {a}_{2} , ⋯ , {a}_{j} , ⋯ , {a}_{p} \} ,$$
$${a}_{j} = \{ {ω}_{j 1} , {ω}_{j 2} , ⋯ , {ω}_{jn} \} ,$$
wherein A represents a resource allocation action space, a₁ represents a first resource allocation action for allocating channel bandwidths to sub-networks, aⱼ represents a j-th resource allocation action for allocating channel bandwidths to sub-networks, aₚ represents a p-th resource allocation action for allocating channel bandwidths to sub-networks, ωᵢ₁ represents channel bandwidths allocated to the first sub-network under the j-th resource allocation action, ωⱼₙ represents channel bandwidths allocated to the n-th sub-network under the j-th resource allocation action, where p is the total number of actions in the resource allocation action space;
a reward function definition submodule, configured to construct a resource allocation reward function according to the frequency domain resource allocation optimization function;
a calculation expression of the resource allocation reward function is as follows:
$$R ( SSR , SE ) = {{f}_{1}}_{s ∈ \{ {s}_{1} , {s}_{2} , ⋯ , {s}_{i} , ⋯ , {s}_{n} \}} ( {SSR}_{s} ) + λ {f}_{2} ( SE ) ,$$
$${{f}_{1}}_{s ∈ \{ {s}_{1} , {s}_{2} , ⋯ , {s}_{i} , ⋯ , {s}_{n} \}} ( {SSR}_{s} ) = {\sum }_{s ∈ \{ {s}_{1} , {s}_{2} , ⋯ , {s}_{i} , ⋯ , {s}_{n} \}} {η}_{s} ( {SSR}_{s} - {SSR}_{0} ) ,$$
$${f}_{s} ( SE ) = γ \cdot ( SE - {SE}_{0} ) ,$$
wherein R(SSR,SE) represents resource allocation reward function,
$${{f}_{1}}_{s ∈ \{ {s}_{1} , {s}_{2} , ⋯ , {s}_{i} , ⋯ , {s}_{n} \}} ( {SSR}_{s} )$$
represents sub-network SLA satisfaction rate reward function, λ represents SLA satisfaction variable weight, f₂(SE) represents frequency domain resource utilization rate reward function, ηₛ represents sub-network priority coefficient, SSR₀ represents lowest SLA satisfaction rate threshold, γ represents frequency domain resource utilization rate weight, SE represents frequency domain resource utilization efficiency, SE₀ represents lowest frequency domain resource utilization efficiency threshold; and
a resource allocation sub-module, configured to predict and obtain an optimal resource allocation state of the sub-network at the next time through deep reinforcement learning according to the resource allocation action space and the resource allocation reward function, and complete allocation of wireless access network frequency domain resources to each sub-network.

7. The information communication management system of claim 6, wherein the resource allocation sub-module comprises:
an execution network unit, configured to obtain a resource allocation action probability distribution according to the execution network parameters, the resource allocation state of the sub-network at the next time and the resource action allocation space, and sample to obtain a target resource allocation action;
an evaluation network unit, configured to evaluate the resource allocation state at each time according to the evaluation network parameters to obtain the resource allocation state value at each time;
a state action evaluation unit, configured to evaluate the resource allocation state of the sub-network at the current time and the target resource allocation action at the current time to obtain a state action evaluation result;
an execution network parameter updating unit, configured to update the execution network parameters based on the execution network parameter update model and the evaluation network parameters at the current moment, the resource allocation state of the subnetwork at the current moment, the target resource allocation action at the current moment, the resource allocation state of the subnetwork at the next moment, and the state action evaluation result;
an evaluation network parameter updating unit, configured to update evaluation network parameters based on an evaluation network parameter updating model according to evaluation network parameters and execution network parameters at the current time, a resource allocation state of the sub-network at the current time, a target resource allocation action at the current time, a resource allocation state of the sub-network at the next time, and a state action evaluation result; and
a resource allocation optimization unit, configured to obtain the optimal resource allocation state of the sub-network at the next time based on the optimal resource allocation model according to the resource allocation reward function, the target resource allocation action and the resource allocation state value at the next time, and complete the allocation of wireless access network frequency domain resources to each sub-network.

8. The information communication management system of claim 7, wherein a calculation expression of the state behavior evaluation result is as follows:
$$G ( {y}_{st} , {a}_{t} ) = {r}_{t} + ϛ V ( {y}_{st + 1} \vert {y}_{st} , {a}_{t} ) - V ( {y}_{st} ) ,$$
wherein G(yₛₜ,aₜ) represents the state action evaluation result, rₜ represents the instant reward obtained by executing the target resource allocation action at the current time in the resource allocation state of the sub-network at the current time, ζ represents the state transition value discount factor, V(yₛₜ₊₁|yₛₜ,aₜ) represents the evaluation value of the resource allocation state of the sub-network at the current time being transferred to the resource allocation state of the sub-network at the next time through the target resource allocation action at the current time, V(yₛₜ) represents the value of the resource allocation state of the sub-network at the current time.

9. The information communication management system of claim 8, wherein the calculation expressions of the execution network parameter update model and the evaluation network parameter update model are respectively as follows:
$${θ}_{a} ⟸ {θ}_{a} + \frac{\partial log π ( {a}_{t} \vert {y}_{st} ; {θ}_{a} )}{\partial {θ}_{a}} ( {r}_{t} + ϛ V ( {y}_{st + 1} ; {θ}_{c} ) - V ( {y}_{st} ; {θ}_{c} ) ) ,$$
$${θ}_{c} ⟸ {θ}_{c} + \frac{\partial V ( {y}_{st} ; {θ}_{c} )}{\partial {θ}_{c}} ( {r}_{t} + ϛ V ( {y}_{st + 1} ; {θ}_{c} ) - V ( {y}_{st} ; {θ}_{c} ) ) ,$$
wherein θₐ represents the execution network parameter, [symbol] represents the assignment update, log represents the logarithmic operation, π(aₜ|yₛₜ;θₐ) represents the probability that the execution network selects the target resource allocation action at the current time in the resource allocation state of the sub-network at the current time, log π(aₜ|yₛₜ; θₐ) represents the logarithm of the probability,
$$\frac{\partial log π ( {a}_{t} \vert {y}_{st} ; {θ}_{a} )}{\partial {θ}_{a}}$$
represents the gradient of the logarithm of the probability with respect to the execution network parameter, V(yₛₜ₊₁;θ_{c}) represents the evaluation value of the evaluation network for the resource allocation state of the sub-network at the next time, V(yₛₜ; θ_{c}) represents the evaluation value of the evaluation network for the resource allocation state of the sub-network at the current time, θ_{c} represents the evaluation network parameter,
$$\frac{\partial V ( {y}_{st} ; {θ}_{c} )}{\partial {θ}_{c}}$$
represents the evaluation value of the evaluation network on the resource allocation state of the sub-network at the current time with respect to the gradient of the evaluation network parameter.

10. The information communication management system of claim 9, wherein a calculation expression of the optimal resource allocation model is as follows:
$${V}^{′} ( {y}_{st + 1} ) = argmax \{ {r}_{t} + ς V ( {y}_{st + 1} \vert {y}_{st} , {a}_{t} ) V ( {y}_{st} ) \} ,$$
wherein V′(yₛₜ₊₁) represents the optimal value of executing the target resource allocation action at the current time in the resource allocation state of the sub-network at the current time to transfer to the resource allocation state of the sub-network at the next time.
